(19) United States
(12) Patent Application Publication
(10) Pub. No.: US 2011/0007776 A1
(43) Pub. Date: Jan. 13, 2011

(54) TEMPERATURE SENSOR

(76) Inventor: Hidenori Yamamoto, Osaka (JP)

Correspondence Address: The Ollila Law Group LLC, 2569 Park Lane, SUITE 202, Lafayette, CO, 80026, US

(21) Appl. No.: 12/920,875

(22) PCT Filed: Mar. 11, 2008
(86) PCT No.: PCT/JP2008/000535

§ 371 Date: Sep. 3, 2010

(51) Int. Cl. G01K 1/08

(52) U.S. Cl. 374/208; 374/E01.011

(57) ABSTRACT

A temperature sensor (100) includes: a temperature detecting element (2) whose electric physical quantity changes depending on a temperature change; a conductor (3a, 3b) configured to transfer a change in the electric physical quantity of the temperature detecting element; and a protecting tube (1) configured to protect the temperature detecting element and at least a part of the conductor. The temperature sensor (100) is configured such that the protecting tube incorporates at least the temperature detecting element and at least the part of the conductor, and an electrical insulating material is filled between the protecting tube and the temperature detecting element and between the protecting tube and at least the part of the conductor. An edible material (5) is filled as the electrical insulating material.

### TECHNICAL FIELD

The present invention relates to a temperature sensor including a temperature detecting element and particularly to a temperature sensor including a temperature detecting element in a protecting tube.

### BACKGROUND ART

A temperature sensor including a temperature detector, such as a thermocouple utilizing Seebeck effect or a resistance thermometer bulb utilizing a change in a resistance value with respect to a temperature change, is excellent in convenience and economical efficiency and is capable of measuring temperatures comparatively accurately in a wide temperature range. Therefore, such temperature sensor has been used in various industrial facilities.

Typically, the temperature sensor includes the temperature detector, such as the thermocouple or the resistance thermometer bulb, inside a resin seal pipe (protecting tube). In a case where the temperature detector is included inside the seal pipe, the seal pipe having a large diameter may be used according to need. Therefore, in accordance with this configuration, the temperature sensor having an excellent mechanical strength and a long-term durability can be easily obtained. However, in a case where the temperature detector is included inside the seal pipe, it is commonly difficult to configure a small-diameter temperature sensor or a minute temperature sensor since the mechanical strength of the seal pipe is comparatively low. In addition, in accordance with this configuration, the heat conductivity of the seal pipe is comparatively low. Therefore, it is commonly difficult to obtain the temperature sensor having excellent responsiveness.

Here, a temperature sensor (hereinafter referred to as “sheath type temperature sensor”) using a metal protecting tube (hereinafter referred to as “sheath”) excellent in mechanical strength and thermal conductivity and including the temperature detector, such as the thermocouple or the resistance thermometer bulb, inside the sheath instead of the resin seal pipe has been preferably used (see Patent Document 1 for example).

In accordance with the configuration of the sheath type temperature sensor, excellent mechanical strength and thermal conductivity can be obtained. In addition, in accordance with the configuration of the sheath type temperature sensor, excellent oxidation resistance and corrosion resistance can be obtained using a stainless steel sheath. Therefore, the sheath type temperature sensor has been preferably used in industrial facilities, such as drug manufacturing facilities and food manufacturing facilities.

Hereinafter, a common configuration of a conventional sheath type temperature sensor including the thermocouple as the temperature detector will be outlined.

FIGS. 4 are schematic diagrams each showing the configuration of the conventional sheath type temperature sensor. Here, FIG. 4(a) is a perspective view schematically showing the configuration of the conventional sheath type temperature sensor. FIG. 4(b) is a cross-sectional view schematically showing the configuration of a sheath portion shown in FIG. 4(a).

In FIG. 4(a), for easier comprehension of an internal configuration of the sheath type temperature sensor, the thermocouple provided inside the sheath type temperature sensor and lead wires connected to the thermocouple are shown by solid lines for convenience sake.

As shown in FIGS. 4(a) and 4(b), a conventional sheath type temperature sensor 200 includes a cylindrical sheath 101 configured such that one end thereof has a conical shape and the other end thereof has an opening. The sheath 101 is formed by stainless steel, such as SUS-304, to adequately secure, for example, the mechanical strength, the thermal conductivity, the oxidation resistance, and the corrosion resistance. In an inner portion (inner side) of the sheath 101, a part of a thermocouple 104 (a tip end portion of the thermocouple 104) is provided. Here, as shown in FIG. 4(a), the thermocouple 104 includes a temperature detecting element 102 and conducting wires 103a and 103b electrically connected to the temperature detecting element 102.

The temperature detecting element 102 of the thermocouple 104 is provided at one end side of the sheath 101 (to be specific, at a tip end side of the sheath type temperature sensor 200). The conducting wires 103a and 103b extend from the temperature detecting element 102 to the other end side of the sheath 101 (to be specific, to a base end side of the sheath type temperature sensor 200). In the sheath type temperature sensor 200, a portion of the thermocouple 104 which portion is incorporated in the sheath 101 is provided in the inner portion (inner side) of the sheath 101 such that: no air gap is formed between the thermocouple 104 and the sheath 101 by filling powder of an inedible material 105, such as magnesium oxide or aluminum oxide, as an electrical insulating material in the inner portion (inner side) of the sheath 101; and the thermocouple 104 is completely electrically insulated from the sheath 101. As shown in FIG. 4(a), the conducting wires 103a and 103b of the thermocouple 104 further extend through the opening of the sheath 101 to outside.

As shown in FIG. 4(a), a cylindrical grip 106 having an outer diameter larger than an outer diameter of the sheath 101 is coupled to the other end of the sheath 101 via a predetermined coupling member. The grip 106 is coupled to the other end of the sheath 101 so as to be coaxial with the sheath 101. As with the sheath 101, the grip 106 is formed by stainless steel, such as SUS-304, so as to have adequate mechanical strength and surely support the sheath 101. The conducting wires 103a and 103b of the thermocouple 104 extending through the opening of the sheath 101 are inserted through an inner portion (inner side) of the grip 106. The conducting wires 103a and 103b are inserted substantially linearly along a long axis direction of the grip 106 so as to extend from one end to the other end of the grip 106. Although not shown in FIG. 4(a), the conducting wires 103a and 103b are provided in the inner portion (inner side) of the grip 106 such that: no air gap is formed between the grip 106 and the conducting wire 103a, 103b by filling a filler, such as silicon resin, in the inner portion (inner side) of the grip 106; and the conducting wires 103a and 103b are completely electrically insulated from the grip 106.

As shown in FIG. 4(a), a lead wire 107 extends from the other end of the grip 106 (to be specific, a portion of the grip 106 which portion is located on the base end side of the sheath type temperature sensor 200) via a predetermined coupling member. Here, the lead wire 107 includes conducting wires 107a and 107b. One end of the conducting wire 107a is electrically connected to one end of the conducting wire 103a of the thermocouple 104. Moreover, one end of the conducting wire 107b is electrically connected to one end of the conducting wire 103b of the thermocouple 104. The other end of each of the conducting wires 107a and 107b is connected to, for example, a connecting terminal of a controller.

The conventional sheath type temperature sensor 200 has excellent mechanical strength and thermal conductivity and also has the oxidation resistance and the corrosion resistance. Therefore, the conventional sheath type temperature sensor 200 is especially preferably used in industrial facilities, such as drug manufacturing facilities and food manufacturing facilities.

Patent Document 1: Japanese Laid-Open Patent Application Publication No. 09-159542

### DISCLOSURE OF THE INVENTION

### Problems to be Solved by the Invention

However, in accordance with the configuration of the conventional sheath type temperature sensor using the inedible material, such as magnesium oxide or aluminum oxide, as the electrical insulating material, in a case where the sheath breaks by a physical impact, the inedible material, such as magnesium oxide or aluminum oxide, filled in the inner portion (inner side) of the sheath scatters. Here, in a case where the industrial facility, such as the food manufacturing line, includes the conventional sheath type temperature sensor, and the inedible material, such as magnesium oxide or aluminum oxide, scatters by the break of the sheath, the scattered inedible material, such as magnesium oxide or aluminum oxide, may get mixed in foods. This becomes a cause of significantly deteriorating safety of foods manufactured in the food manufacturing line. In the worst case, the shipping of foods may have to be stopped.

The present invention was made to solve the above problems, and an object of the present invention is to provide a sheath type temperature sensor configured to use a material harmless to humans as an electrical insulating material and not to contaminate foods even in a case where the sheath breaks to scatter the electrical insulating material.

### Means for Solving the Problems

To solve the above problem, a temperature sensor according to the present invention includes: a temperature detecting element whose electric physical quantity changes depending on a temperature change; a conductor configured to transfer a change in the electric physical quantity of the temperature detecting element; and a protecting tube configured to protect the temperature detecting element and at least a part of the conductor, the temperature sensor being configured such that the protecting tube incorporates at least the temperature detecting element and at least the part of the conductor, and an electrical insulating material is filled between the protecting tube and the temperature detecting element and between the protecting tube and at least the part of the conductor, wherein an edible material is filled as the electrical insulating material.

With this configuration, since the edible material harmless to humans is filled in the protecting tube as the electrical insulating material, it is possible to provide the sheath type temperature sensor which does not contaminate foods even in a case where the sheath breaks to scatter the electrical insulating material.

In this case, the edible material is a plant-derived material containing a plurality of phenolic hydroxy groups in a molecular framework.

With this configuration, since the plant-derived material containing a plurality of phenolic hydroxy groups in the molecular framework is used as the edible material, it is possible to provide the sheath type temperature sensor which is safe and preferable.

In this case, the plant-derived material is polyphenol.

With this configuration, since the polyphenol is used as the plant-derived material, it is possible to provide the sheath type temperature sensor which is further safe, preferable, and comparatively inexpensive.

In this case, the polyphenol is 3,5,7,3′,4′-pentahydroxyflavan.

With this configuration, since the 3,5,7,3′,4′-pentahydroxyflavan, i.e., catechin is used as the polyphenol, it is possible to provide the sheath type temperature sensor which considers not only the safety but also a health aspect.

Moreover, in the above case, the polyphenol is a (1S ,3R,4R,5R)-3-{[3-(3,4-dihydroxyphenyl)acryloyl]oxy}-1,4,5-trihydroxycyclohexane--carboxylic acid.

Even with this configuration, since the (1S,3R,4R,5R)-3-{[3-(3,4-dihydroxyphenyl)acryloyl]oxy}-1,4,5-trihydroxycyclohexane-1-carboxylic acid, i.e., a chlorogenic acid is used as the polyphenol, it is possible to provide the sheath type temperature sensor which considers not only the safety but also the health aspect.

Moreover, in the above case, the edible material is a plant-derived material containing polysaccharide having a1→4 bond D-glucan as a main chain.

With this configuration, since the plant-derived material containing polysaccharide having a1→4 bond D-glucan as the main chain is used as the edible material, it is possible to provide the sheath type temperature sensor which is safe and preferable.

In this case, the plant-derived material is flour.

With this configuration, since the flour is used as the plant-derived material, it is possible to provide the sheath type temperature sensor which is very safe, preferable, and inexpensive.

Moreover, in this case, the plant-derived material is dogtooth violet starch.

Even with this configuration, since the dogtooth violet starch is used as the plant-derived material, it is possible to provide the sheath type temperature sensor which is very safe, preferable, and inexpensive.

### EFFECTS OF THE INVENTION

The present invention is carried out by the above-described means for solving the problems. Thus, it is possible to provide the sheath type temperature sensor which uses the material harmless to humans as the electrical insulating material and does not contaminate foods even in a case where the sheath breaks to scatter the electrical insulating material.

### BRIEF DESCRIPTION OF THE DRAWINGS

FIGS. 1 are schematic diagrams each showing the configuration of a sheath type temperature sensor according to Embodiment of the present invention. FIG. 1(a) is a perspective view schematically showing the configuration of the sheath type temperature sensor according to Embodiment of the present invention. FIG. 1(b) is a cross-sectional view schematically showing the configuration of a sheath portion shown in FIG. 1(a).

FIGS. 2 are structure diagrams each showing a chemical structure of an edible material according to Embodiment of the present invention. FIG. 2(a) is a structure diagram showing the structure of catechin. FIG. 2(b) is a structure diagram showing the structure of a chlorogenic acid.

FIG. 3 is a graph showing results of an electrical insulation property test of the edible material according to Embodiment of the present invention.

FIGS. 4 are schematic diagrams each showing the configuration of a conventional sheath type temperature sensor. FIG. 4(a) is a perspective view schematically showing the configuration of the conventional sheath type temperature sensor. FIG. 4(b) is a cross-sectional view schematically showing the configuration of the sheath portion shown in FIG. 4(a).

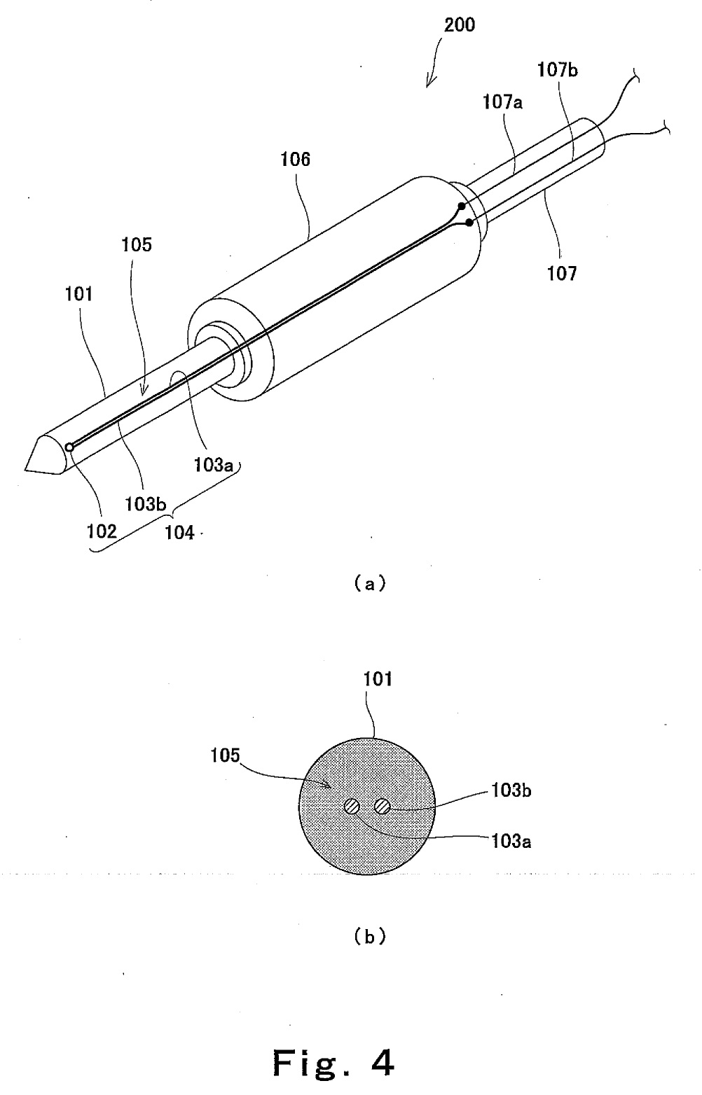

### EXPLANATION OF REFERENCE NUMBERS

1 sheath
2 temperature detecting element
3a, 3b conducting wire
4 thermocouple
5 edible material
6 grip
7 lead wire
7a, 7b conducting wire
100 temperature sensor
101 sheath
102 temperature detecting element
103a, 103b conducting wire
104 thermocouple
105 inedible material
106 grip
107 lead wire
107a, 107b conducting wire
200 temperature sensor

### BEST MODE FOR CARRYING OUT THE INVENTION

Hereinafter, best mode for carrying out the present invention will be explained in detail in reference to the drawings.

In the present specification, materials orally ingested frequently, materials which may be orally ingested frequently, and materials basically harmless to humans even if orally ingested frequently or infrequently are defined as “edible materials.”

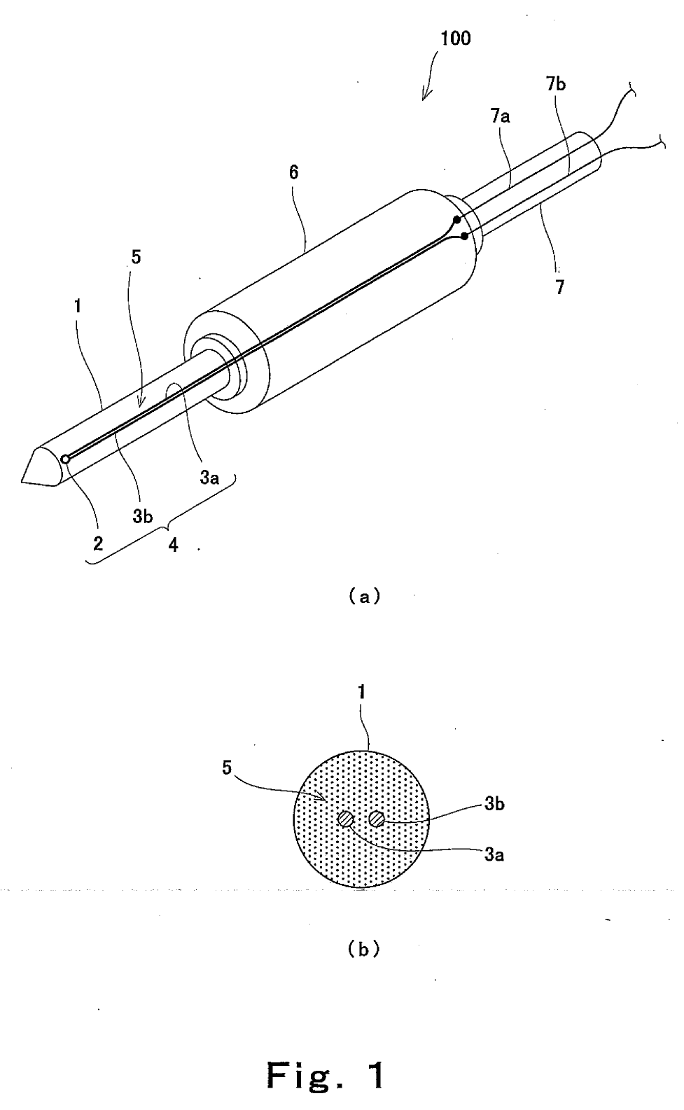

FIGS. 1 are schematic diagrams each showing the configuration of a sheath type temperature sensor according to Embodiment of the present invention. FIG. 1(a) is a perspective view schematically showing the sheath type temperature sensor according to Embodiment of the present invention. FIG. 1(b) is a cross-sectional view schematically showing the configuration of a sheath portion shown in FIG. 1(a).

In FIG. 1(a), for easier comprehension of the internal configuration of the sheath type temperature sensor, a thermocouple provided inside the sheath type temperature sensor and lead wires connected to the thermocouple are shown by solid lines for convenience sake.

As shown in FIGS. 1(a) and 1(b), a sheath type temperature sensor 100 according to Embodiment of the present invention includes a cylindrical sheath 1 configured such that one end thereof has a conical shape and the other end thereof has an opening. The sheath 1 is formed by stainless steel, such as SUS-304, to adequately secure, for example, the mechanical strength, the thermal conductivity, the oxidation resistance, and the corrosion resistance. In an inner portion (inner side) of the sheath 1, a part of a thermocouple 4 (a tip end portion of the thermocouple 4) is provided. Here, the thermocouple 4 includes a temperature detecting element 2 and conducting wires 3a and 3b electrically connected to the temperature detecting element 2.

The temperature detecting element 2 of the thermocouple 4 is provided at one end side of the sheath 1 (to be specific, at a tip end side of the sheath type temperature sensor 100). The conducting wires 3a and 3b extend from the temperature detecting element 2 to the other end side of the sheath 1 (to be specific, to a base end side of the sheath type temperature sensor 100). In the sheath type temperature sensor 100 of the present embodiment, a portion of the thermocouple 4 which portion is incorporated in the sheath 1 is provided in the inner portion (inner side) of the sheath 1 such that: no air gap is formed between the thermocouple 4 and the sheath 1 by filling a powder edible material 5 as an electrical insulating material in the inner portion of the sheath 1; and the thermocouple 4 is completely electrically insulated from the sheath 1. As shown in FIG. 1(a), the conducting wires 3a and 3b of the thermocouple 4 further extend through the opening of the sheath 1 to outside.

As shown in FIG. 1(a), a cylindrical grip 6 having an outer diameter larger than an outer diameter of the sheath 1 is coupled to the other end of the sheath 1 via a predetermined coupling member. The grip 6 is coupled to the other end of the sheath 1 so as to be coaxial with the sheath 1. As with the sheath 1, the grip 6 is formed by stainless steel, such as SUS-304, so as to have adequate mechanical strength and surely support the sheath 1. The conducting wires 3a and 3b of the thermocouple 4 extending through the opening of the sheath 1 are inserted through an inner portion (inner side) of the grip 6. The conducting wires 3a and 3b are inserted substantially linearly along a long axis direction of the grip 6 so as to extend from one end to the other end of the grip 6. Although not shown in FIG. 1(a), the conducting wires 3a and 3b are provided in the inner portion (inner side) of the grip 6 such that: no air gap is formed between the grip 6 and the conducting wire 3a, 3b by filling a filler, such as silicon resin, in the inner portion (inner side) of the grip 6; and the conducting wires 3a and 3b are completely electrically insulated from the grip 6.

As shown in FIG. 1(a), a lead wire 7 extends from the other end of the grip 6 (to be specific, a portion of the grip 6 which portion is located on the base end side of the sheath type temperature sensor 100) via a predetermined coupling member. The lead wire 7 includes conducting wires 7a and 7b. One end of the conducting wire 7a is electrically connected to one end of the conducting wire 3a of the thermocouple 4. Moreover, one end of the conducting wire 7b is electrically connected to one end of the conducting wire 3b of the thermocouple 4. The other end of each of the conducting wires 7a and 7b is electrically connected to, for example, a connecting terminal of a controller.

In Embodiment of the present invention, a plant-derived material containing a plurality of phenolic hydroxy groups in a molecular framework or a plant-derived material containing polysaccharide having a1→4 bond D-glucan as a main chain is used as the edible material 5 that is the electrical insulating material. Hereinafter, details of the edible material used in the present invention will be explained.

First, the following will explain a case where the plant-derived material containing a plurality of phenolic hydroxy groups in the molecular framework is used as the edible material 5.

In Embodiment of the present invention, polyphenol is used as the edible material 5. For example, used as the polyphenol is 3,5,7,3′,4′-pentahydroxyflavan. The 3,5,7,3′,4′-pentahydroxyflavan is commonly called catechin. Moreover, for example, used as the polyphenol is a (1S,3R,4R,5R)-3-{[3-(3,4-dihydroxyphenyl)acryloyl]oxy}-1,4,5-trihydroxycyclohexane-1-carboxylic acid. This is commonly called a chlorogenic acid.

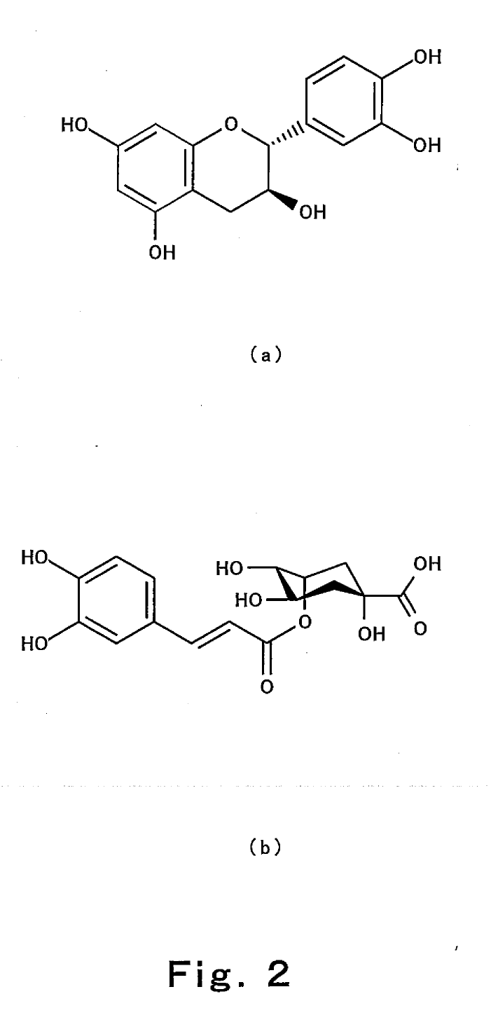

FIGS. 2 are structure diagrams each showing a chemical structure of the edible material according to Embodiment of the present invention. FIG. 2(a) is a structure diagram showing the structure of the catechin. FIG. 2(b) is a structure diagram showing the structure of the chlorogenic acid.

As shown in FIG. 2(a), (+)-catechin has five phenolic hydroxy groups. Here, a melting point of tetrahydrate of the (+)-catechin is 96° C. Moreover, a melting point of anhydride of the (+)-catechin is 175 to 177° C. In addition to the (+)-catechin, as the catechin, there is (−)-epicatechin that is a diastereomer of the (+)-catechin. A melting point of the (−)-epicatechin is 245° C. Note that the (+)-catechin and the (−)-epicatechin exist in various plants. For example, a large amount of catechin is contained in a water extract of catechu which is a legume from India and is also called gambir. Moreover, the catechin is widely known as an astringency component in tea. Further, it is reported that the catechin has various bioactive effects. Examples of the bioactive effect of the catechin are a blood pressure increase suppressing effect, a blood cholesterol adjusting effect, a blood sugar level adjusting effect, an antioxidant effect, an aging suppressing effect, an antimutagenic effect, an anticancer effect, an antibacterial effect, an anticaries effect, and antiallergic effect.

As shown in FIG. 2(b), the chlorogenic acid has two phenolic hydroxy groups. The chlorogenic acid is also called a 5-caffeoylquinic acid. Here, the chlorogenic acid is a compound obtained by dehydrocondensation of a carboxyl group of a caffeic acid and a hydroxy group of 5-position of a quinic acid. The chlorogenic acid is a compound having been isolated from coffee beans for the first time. Currently, the chlorogenic acid can be extracted from seeds and leaves of various dicotyledonous plants. Moreover, the chlorogenic acid is thermally unstable and easily decomposed into a caffeic acid and a quinic acid. Therefore, in the case of using the chlorogenic acid as the electrical insulating material of the sheath type temperature sensor 100, it is necessary to pay attention to an operating temperature range of the sheath type temperature sensor. In addition, it is reported that the chlorogenic acid have many bioactive effects. For example, one example of the bioactive effects of the chlorogenic acid is an antioxidant effect.

Next, the following will explain a case where the plant-derived material containing polysaccharide having a1→4 bond D-glucan as the main chain is used as the edible material 5.

In Embodiment of the present invention, flour or dogtooth violet starch can be used as the edible material 5.

The flour can be easily obtained by, for example, grinding wheat. A major component of the flour is starch as polysaccharide having a1→4 bond D-glucan as the main chain. A minor component of the flour is protein. Here, major examples of the protein are gliadin and glutenin. Commonly, the flour is not limited to powder obtained by grinding wheat. For example, the flour includes powder obtained by grinding rice, buckwheat, potato, and the like. The dogtooth violet starch is powder obtained by refining starch obtained from a root of dogtooth violet that is a perennial of Liliaceae. In recent years, the original dogtooth violet starch obtained from the dogtooth violet is not distributed so much, but the dogtooth violet starch obtained from the potato is widely distributed in the market. In the present embodiment, the flour or the dogtooth violet starch derived from various plants is used as the edible material 5.

As above, in Embodiment of the present invention, the edible material, such as polyphenol, flour, or dogtooth violet starch, is used as the edible material 5 that is the electrical insulating material with which the sheath 1 of the sheath type temperature sensor 100 is filled. These edible materials are harmless to humans even if they are orally infested frequently. Therefore, in accordance with this configuration, it is possible to provide the sheath type temperature sensor 100 which does not contaminate foods even if the sheath breaks to scatter the electrical insulating material.

Next, results of an electrical insulation property test of the sheath type temperature sensor 100 using the edible material, such as polyphenol, flour, or dogtooth violet starch, as the electrical insulating material will be explained.

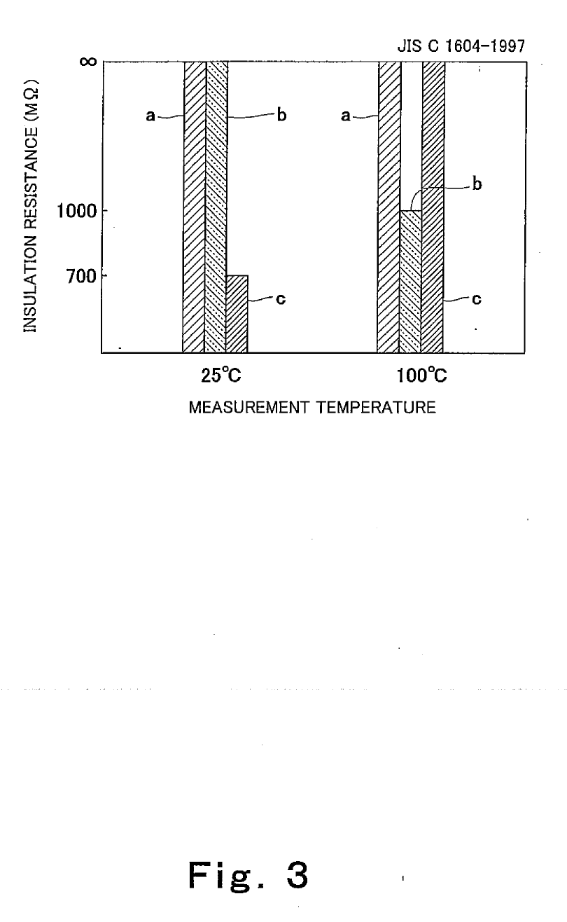

FIG. 3 is a graph showing the results of the electrical insulation property test of the edible material according to Embodiment of the present invention. The electrical insulation property test was carried out based on Japanese Industrial Standards (JIS) C 1604-1997. Moreover, the electrical insulation property test was carried out at a temperature of 25° C. and at a humidity of 62%.

As shown in FIG. 3, when a measurement temperature was 25° C., each of an insulation resistance of the polyphenol shown by a bar graph a and an insulation resistance of the flour shown by a bar graph b was ∞. In this case, an insulation resistance of the dogtooth violet starch shown by a bar graph c was 700 MΩ. Meanwhile, as shown in FIG. 3, when the measurement temperature was 100° C., each of the insulation resistance of the polyphenol shown by the bar graph a and the insulation resistance of the dogtooth violet starch shown by the bar graph c was ∞. In this case, the insulation resistance of the flour shown by the bar graph b was 1,000 MΩ.

It was found from the above test results that the edible material according to the present embodiment has the same insulation property as magnesium oxide or aluminum oxide conventionally used as the electrical insulating material. With this, it was found that even in a case where the edible material is used as the electrical insulating material, electrical insulation between the thermocouple 4 and the sheath 1 shown in FIGS. 1(a) and 1(b) can be surely secured. In Embodiment of the present invention, the edible material 5 used as the electrical insulating material is sealed in the inner portion (inner side) of the sheath 1 of the sheath type temperature sensor 100. To be specific, in Embodiment of the present invention, since the edible material 5 does not contact oxygen, the other oxidized gas, a corrosive gas, or the like, the edible material 5 of the sheath type temperature sensor 100 does not denature or alter. Therefore, in accordance with the configuration of the sheath type temperature sensor 100 according to the present invention, it is possible to provide the preferable sheath type temperature sensor showing desired electric characteristic and safety for a long period of time.

In Embodiment of the present invention, each of the catechin and the chlorogenic acid is exemplified as the polyphenol. However, the present embodiment is not limited to these. For example, any polyphenol may be used as long as it is an aromatic hydroxy compound in which two or more hydrogen atoms of an aromatic hydrocarbon nucleus are replaced with hydroxy groups and which is harmless to humans. Examples of the polyphenol other than the catechin and the chlorogenic acid are lignan richly contained in sesame, curcumin richly contained in turmeric, and an ellagic acid richly contained in strawberry.

Moreover, in Embodiment of the present invention, each of the flour and the dogtooth violet starch is exemplified as the edible material. However, the present embodiment is not limited to these. For example, barley flour or rice flour may be used as the edible material. In addition, glycerin may be used as the edible material.

Moreover, in Embodiment of the present invention, the edible material having the same insulation resistance as magnesium oxide or aluminum oxide is used. However, the edible material having the insulation resistance slightly lower than that of magnesium oxide or aluminum oxide may be used as the electrical insulating material. In this case, the thermocouple and the sheath can be surely electrically insulated from each other by covering the entire thermocouple with silicon resin or fluorocarbon resin.

Moreover, in Embodiment of the present invention, the thermocouple is used as the temperature detector. However, the present embodiment is not limited to this. For example, the sheath type temperature sensor may be configured by using a resistance thermometer bulb, such as a thermistor, or a platinum resistor instead of the thermocouple. In accordance with this configuration, effects similar to the effects obtained by the sheath type temperature sensor according to Embodiment of the present invention can be obtained.

Moreover, in the present embodiment, the sheath is used as the protecting tube. However, the present embodiment is not limited to this. For example, a seal pipe may be used as the protecting tube. In accordance with this configuration, effects similar to the effects obtained by the sheath type temperature sensor according to Embodiment of the present invention can be obtained.

Further, in Embodiment of the present invention, the temperature sensor including the sheath and the grip is exemplified. However, the present embodiment is not limited to this. For example, the present invention is applicable to the temperature sensor configured such that the sheath and a terminal box incorporating a connecting terminal electrically connected to the temperature detector, such as a thermocouple, are directly or indirectly coupled to each other. In accordance with this configuration, effects similar to the effects obtained by the sheath type temperature sensor according to Embodiment of the present invention can be obtained.

### INDUSTRIAL APPLICABILITY

The temperature sensor according to the present invention adequately has industrial applicability as a temperature sensor preferably used in various industrial facilities, such as a food manufacturing line in which electronic temperature control is performed.

Moreover, the temperature sensor according to the present invention adequately has industrial applicability as a sheath type temperature sensor which uses as the electrical insulating material a material harmless to humans and does not contaminate foods even in a case where the sheath breaks to scatter the electrical insulating material.

1. A temperature sensor comprising:
a temperature detecting element whose electric physical quantity changes depending on a temperature change;
a conductor configured to transfer a change in the electric physical quantity of the temperature detecting element; and
a protecting tube configured to protect the temperature detecting element and at least a part of the conductor,
the temperature sensor being configured such that the protecting tube incorporates at least the temperature detecting element and at least the part of the conductor, and an electrical insulating material is filled between the protecting tube and the temperature detecting element and between the protecting tube and at least the part of the conductor, wherein
an edible material is filled as the electrical insulating material.

2. The temperature sensor according to claim 1, wherein the edible material is a plant-derived material containing a plurality of phenolic hydroxy groups in a molecular framework.

3. The temperature sensor according to claim 2, wherein the plant-derived material is polyphenol.

4. The temperature sensor according to claim 3, wherein the polyphenol is 3,5,7,3′,4′-pentahydroxyflavan.

5. The temperature sensor according to claim 3, wherein the polyphenol is a (1S,3R,4R,5R)-3-{[3-(3,4-dihydroxyphenyl)acryloyl]oxy}-1,4,5-trihydroxycyclohexane-1-carboxylic acid.

6. The temperature sensor according to claim 1, wherein the edible material is a plant-derived material containing polysaccharide having a1→4 bond D-glucan as a main chain.

7. The temperature sensor according to claim 6, wherein the plant-derived material is flour.

8. The temperature sensor according to claim 6, wherein the plant-derived material is dogtooth violet starch.
